(19) United States
(12) Patent Application Publication
(10) Pub. No.: US 2004/0143813 A1
(43) Pub. Date: Jul. 22, 2004

(54) System development supporting apparatus, system development supporting method, and computer-readable recorded medium

(76) Inventor: Kentaro Hanma, Tokyo (JP)

Correspondence Address: Stephen M Chin, Reed Smith, 375 Park Avenue, New York, NY, 10152-1799, US

(21) Appl. No.: 10/031,965

(22) PCT Filed: May 30, 2001
(86) PCT No.: PCT/JP01/04533

(51) Int. Cl. G06F 9/44

(52) U.S. Cl. 717/104; 717/140; 717/174

(57) ABSTRACT

A division means divides a program, in which a logic specification of a system is described in a single high-level language, into a hardware portion and a software portion based on division information which designates each portion of the program as either the hardware portion or the software portion. A storage means stores a program of the hardware portion and a program of the software portion which are divided by the division means. A first conversion means converts the program of the hardware portion stored in the storage means into a circuit specification. A second conversion means converts the program of the software portion stored in the storage means into an execute form module.

### TECHNICAL FIELD

The present invention relates to a system development support device, a system development support method, and a computer readable record medium which are used when a system, in which a hardware portion and a software portion mingle, is developed.

### BACKGROUND ART

When electronic equipment such as a cellular phone is developed, its functions are realized using both hardware and software in many cases.

FIG. 7 is a block diagram showing an example of a system 101 in electronic equipment in which a hardware portion and a software portion mingle.

In the system 101 shown in FIG. 7, an MPU (Micro Processing Unit) 111 is an operation unit which executes programs, stored in a ROM 113, a RAM 114, and a flash ROM 115, as the software portion of the system 101.

A DSP (Digital Signal Processor) 112 is a circuit which realizes specific processing as hardware.

Moreover, the ROM 113 is a memory which previously stores programs and data. The RAM 114 is a memory which, at the time of execution of the programs, temporarily stores the programs and data. The flash ROM 115 is a nonvolatile memory which can be rewritten its contents after shipment of a product.

A register group 116 is a circuit which holds various kinds of data when the programs are executed.

A gate array 117 is a logic circuit mounted as the hardware portion of the system 101.

A peripheral circuit 118 is a circuit which, for example, controls peripheral equipment not illustrated and gives and receives data to/from other devices.

In such electronic equipment having the system 101, processing according to information obtained by the peripheral circuit 118 or a user's command is executed along the programs by the MPU 111, executed by the gate array 117, or executed by the cooperation of both of them.

Next, a conventional system development method used when such a system 101 is developed will be explained. FIG. 8 is a flowchart explaining the conventional system development method.

First of all, in the conventional system development method, a basic specification including functions which the system 101 of the electronic equipment is desired to have, designation of a portion to be realized as hardware and a portion to be realized as software out of the functions, and types of a CPU core and a gate array to be used, and the like is settled on as sentences or drawings (step S101). Various knowledge is required to designate the portion to be realized as hardware and the portion to be realized as software and determine the types of the CPU core and the gate array to be used and the like in such a basic specification, and hence the determination thereof is made by an expert having advanced knowledge in many cases.

Thereafter, a logic specification corresponding to the software portion in the basic specification is described in a form of a program in high-level language such as Programming Language C by a software developer (step S111). This program is then compiled to generate an object module (step S112). Modules in libraries are linked to this object module as required to generate an execute form module (step S113).

Meanwhile, a logic specification corresponding to the hardware portion in the basic specification is described in a form of a program in language such as HDL (Hardware Description Language) or the like by a hardware developer. This program is then compiled (step S122) to generate a program in which a circuit specification is described in language such as RTL (Register Transfer Level) or the like, and a circuit layout is generated from the program in which this circuit specification is described (step S123).

As stated above, the software portion of the system 101 is generated from the logic specification of the software portion, and the hardware portion of the system 101 is generated from the logic specification of the hardware portion.

By using a verification program previously generated from the basic specification, the verification of the software portion and the hardware portion of this system 101 is executed (step S114, step S124).

Whether verification results of the software portion and the hardware portion are respectively favorable or not, that is, whether the respective portions operate in accordance with their specifications or not is decided (step S115, step S125).

When the verification results are not favorable, the procedure returns to the step of logic design of software (step S111) and/or the step of logic design of hardware (step S121) according to the verification results, and logic designs are amended respectively or a basic design is changed depending on the situation.

The software developer and the hardware developer amend the logic designs or the basic design while repeating trial and error until favorable verification results of both the software portion and the hardware portion can be obtained.

On this occasion, the software developer has less knowledge of hardware than software, while the hardware developer has less knowledge of software than hardware, and therefore cooperative work between the software developer and the hardware developer is difficult, whereby a lot of time is generally required for this amendment.

After the favorable verification results are obtained finally, the system 101 is generated as an IC chip based on the obtained system logic (step S102).

As stated above, in the conventional system development method, however, the cooperative work between the software developer and the hardware developer is difficult and much time is required for this amendment of designs, which causes a problem that it takes a long time to complete the system.

The present invention is made to solve the aforesaid problem, and its object is to provide a system development support device, a system development support method, and a computer readable record medium which are capable of shortening the time required to complete a system.

### DISCLOSURE OF THE INVENTION

A system development support device of the present invention comprises: a division means for dividing a program, in which a logic specification of a system is described in a single high-level language, into a hardware portion and a software portion based on division information which designates each portion of the program as either the hardware portion or the software portion; a storage means for storing a program of the hardware portion and a program of the software portion which are divided by the division means; a first conversion means for converting the program of the hardware portion stored in the storage means into a circuit specification; and a second conversion means for converting the program of the software portion stored in the storage means into an execute form module.

Use of this system development support device enables a reduction in the time required to complete the system in which the hardware portion and the software portion mingle.

Moreover, in addition to the aforesaid system development support device of the present invention, a system development support device of the present invention allows the division means to determine, in each function block of the program described in the single high-level language, whether the function block is a portion to be mounted as hardware or a portion to be mounted as software based on the division information.

If this system development support device is used, the portion to be mounted as hardware and the portion to be mounted as software can be divided appropriately.

Further, a system development support device of the present invention comprises a division information generating means for generating the division information based on a specification of the system in addition to the aforesaid respective system development support devices of the present invention.

Use of this system development support device makes it possible to generate appropriate division information even if a system developer is not an expert.

Furthermore, in addition to the aforesaid respective system development support devices of the present invention, a system development support device of the present invention allows the division information generating means to generate the division information based on the capacity of a memory in which the execute form module is stored in the system and the number of gates of a gate array in which a circuit based on the circuit specification is performed in the system or based on at least one of a type of a CPU core used in the system, a function of a DSP used in the system, available hardware macros, and available software macros as well as the capacity of the memory and the number of the gates.

If this development support device is used, more appropriate division information can be generated by generating the division information based on these parameters in the specification of the system.

In addition to the aforesaid respective system development support devices of the present invention, a system development support device of the present invention comprises a verification means for verifying a circuit based on the circuit specification converted by the first conversion means and an operation of the execute form module converted by the second conversion means.

By using this system development support device, the entire logic of the system generated from a target program in which the logic specification is described is verified collectively, and hence in addition to the verification of respective operations of the hardware portion and the software portion, an operation based on cooperation between both the portions can be verified.

Moreover, a system development support device of the present invention comprises a division information changing means for changing the division information in accordance with a result of verification by the verification means in addition to the aforesaid respective system development support devices of the present invention.

When this system development support device is used, the frequency of setting/change of the division information by the system developer is reduced, whereby especially the working volume of a rare expert can be reduced and the time required for the development of the system can be further shortened.

Further, in addition to the aforesaid respective system development support devices of the present invention, a system development support device of the present invention allows the division information changing means to change the ratio of the hardware portion to the software portion in accordance with a result of verification by the verification means.

If this system development support device is used, without hardware conditions (the capacity of the memory, the number of gates, and the like) of the system being particularly changed, a circuit which meets the hardware conditions is designed

Furthermore, in addition to the aforesaid respective system development support devices of the present invention, a system development support device of the present invention comprises a first condition changing means for changing a hardware condition in accordance with a result of verification by the verification means, and the first conversion means converts the program of the hardware portion to the circuit specification in accordance with hardware conditions of the system.

Use of this system development support device results in a reduction in the frequency of change of the hardware conditions by the system developer, whereby especially the working volume of the rare expert can be reduced and the time required for the development of the system can be further shortened.

Furthermore, in addition to the aforesaid respective system development support devices of the present invention, a system development support device of the present invention allows the first condition changing means to change input/output timing of signals between the hardware portion and the software portion in accordance with the result of the verification by the verification means.

By using this system developing support device, poor operation due to transmission of signals between the hardware portion and the software portion can be avoided.

Moreover, a system development support device of the present invention comprises a second condition changing means for changing a compile condition on which the second conversion means converts the program of the software portion into the execute form module in accordance with the result of the verification by the verification means, in addition to the aforesaid respective system development support devices of the present invention.

Using this system development support device results in a reduction in the frequency of change of software compile conditions by the system developer, whereby especially the working volume of the rare expert can be reduced and the time required for the development of the system can be further shortened.

Further, in addition to the aforesaid respective system development support devices of the present invention, a system development support device of the present invention allows the second condition changing means to change the type of a CPU core used in the system in accordance with the result of the verification by the verification means.

If this system development support device is used, the operating speed of the entire software portion can be regulated.

Furthermore, in addition to the aforesaid respective system development support devices of the present invention, a system development support device of the present invention comprises an optimization means for repeatedly operating the division means, the first conversion means, the second conversion means and the verification means while changing at least one of the division information, hardware conditions on which the first conversion means converts the program of the hardware portion into the circuit specification, and compile conditions on which the second conversion means converts the program of the software portion into the execute form module, until a predetermined verification result is obtained or only a predetermined number of repetitions.

Using this system development support device results in a further reduction in the frequency of setting/change of the division information by the system developer, whereby especially the working volume of the rare expert can be reduced and the time required for the development of the system can be further shortened.

A system development support method of the present invention comprises the steps of: dividing a program, in which a logic specification of a system is described in a single high-level language, into a hardware portion and a software portion based on division information which designates each portion of the program as either the hardware portion or the software portion and storing the program of the hardware portion and the program of the software portion in a storage means; converting the program of the hardware portion stored in the storage means into a circuit specification; and converting the program of the software portion stored in the storage means into an execute form module.

Use of this system development support method enables a reduction in the time required to complete the system in which the hardware portion and the software portion mingle.

A system development support program recorded on a computer readable record medium of the present invention allows a computer to function as: a division means for dividing a program, in which a logic specification of a system is described in a single high-level language, into a hardware portion and a software portion based on division information which designates each portion of the program as either the hardware portion or the software portion and storing the program of the hardware portion and the program of the software portion in a storage means; a first conversion means for converting the program of the hardware portion stored in the storage means into a circuit specification; and a second conversion means for converting the program of the software portion stored in the storage means into an execute form module.

Use of this system development support program enables a reduction in the time required to complete the system in which the hardware portion and the software portion mingle.

A division program recorded on a computer readable record medium of the present invention allows a computer to function as a division means for dividing a program, in which a logic specification of a system is described in a single high-level language, into a hardware portion and a software portion based on division information which designates each portion of the program as either the hardware portion or the software portion and storing a program of the hardware portion and a program of the software portion in a storage means.

Using this division program makes it possible to describe the logic specification of the system in which the hardware portion and the software portion mingle in the single high-level language, leading to improvement in the development efficiency of the system.

### BRIEF DESCRIPTION OF DRAWINGS

FIG. 1 is a block diagram showing the configuration of a system development support device according to an embodiment 1 of the present invention;

FIG. 2 is a flowchart explaining operations of the system development support device shown in FIG. 1;

FIG. 3 is a flowchart explaining the procedure for developing a system when the system development support device of the embodiment 1 is used;

FIG. 4 is a block diagram showing the configuration of a system development support device according to an embodiment 2 of the present invention;

FIG. 5 is a block diagram showing the configuration of a system development support device according to an embodiment 3 of the present invention;

FIG. 6 is a flowchart explaining operations of the system development support device shown in FIG. 5;

FIG. 7 is a block diagram showing an example of a system in electronic equipment in which a hardware portion and a software portion mingle; and

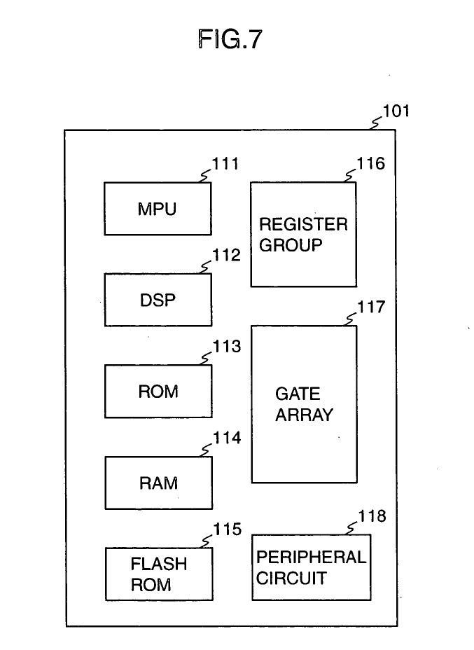

FIG. 8 is a flowchart explaining a conventional system development method.

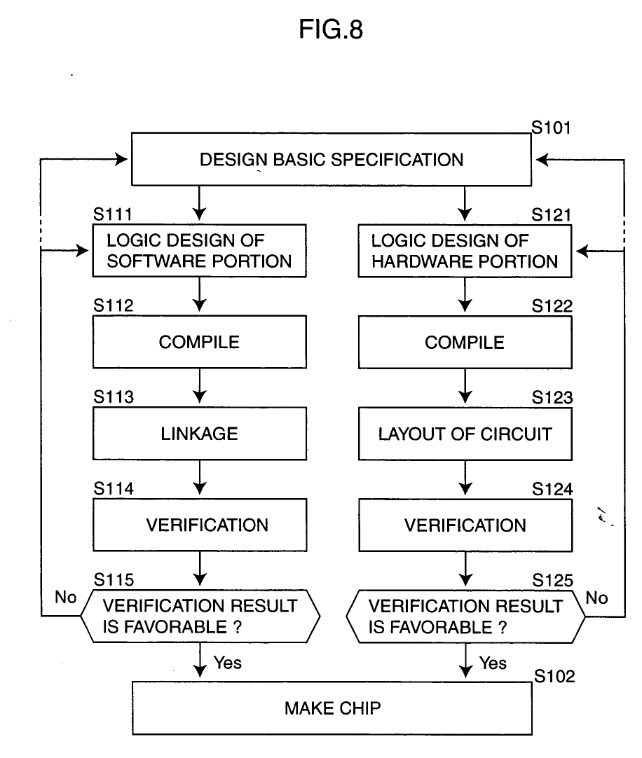

### BEST MODE FOR CARRYING OUT THE INVENTION

Embodiments of the present invention will be explained concretely below based on the drawings.

Embodiment 1.

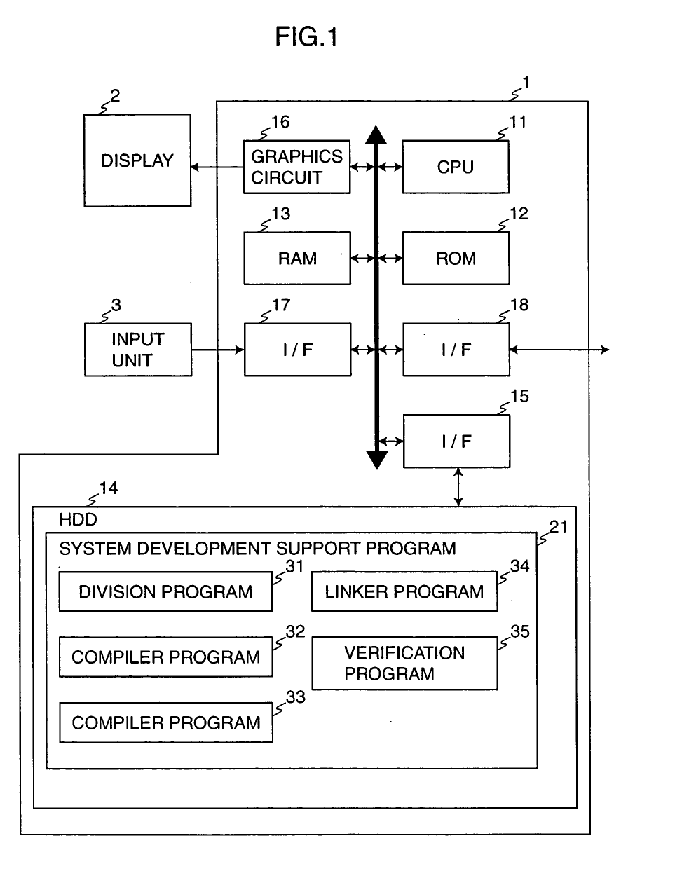

FIG. 1 is a block diagram showing the configuration of a system development support device according to the embodiment 1 of the present invention.

In FIG. 1, a computer 1 is a device which executes a system development support program 21 and functions as a system development support device. A display 2 is a device which displays an image in response to a signal from a graphics circuit 16 of the computer 1. An input unit 3 is a device such as a keyboard, a mouse, or the like which is manipulated by a developer and supplies a signal which complies with the manipulation to the computer 1.

In the computer 1, a CPU 11 executes programs such as an operating system not illustrated, the system development support program 21, and the like. A ROM 12 is a memory which previously stores data, programs, and the like necessary for the starting of the computer 1, and a RAM 13 is a memory as a storage means for temporarily storing the programs and the data during the execution of the programs such as the system development support program 21 and the like.

Moreover, a hard disk drive (hereinafter referred to as HDD) 14 is a device having a record medium for storing the system development support program 21 and other programs such as the operating system not illustrated. Incidentally, the record medium for storing these programs is not limited to the HDD being a magnetic record medium, but may be a magnetic disk, an optical disk, an optical magnetic disk, or the like such as a flexible disk or a compact disk.

The system development support program 21 stored in the HDD 14 is a program including a division program 31, a compiler program 32, a compiler program 33, a linker program 34, and a verification program 35.

The division program 31 is a program which allows the computer 1 to function as a division means for dividing a program, in which a logic specification of a system is described in a single high-level language, into a hardware portion and a software portion based on division information which designates each portion of the program as either the hardware portion or the software portion and storing a program of the hardware portion and a program of the software portion in the RAM 13 or the HDD 14.

The compiler program 32 is a program which allows the computer 1 to function as a first conversion means for converting the high-level language program of the hardware portion stored in the RAM 13 or the HDD 14 into a circuit specification.

The compiler program 33 and the linker program 34 are programs which allow the computer 1 to function as a second conversion means for converting the high-level language program of the software portion stored in the RAM 13 or the HDD 14 into an execute form module.

The compiler program 33 is a program for converting the program of the software portion stored in the RAM 13 or the HDD 14 into an object module, and the linker program 34 is a program for generating the execute form module from the object module or generating the execute form module by linking the object module, a library not illustrated, and other object modules.

The verification program 35 is a program generated based on a verification specification corresponding to the logic specification of the system and allowing the computer 1 to function as a verification means for verifying a circuit based on the circuit specification converted by the compiler program 32 and the operation of the execute form module converted by the compiler program 33 and the linker program 34.

An interface 15 is a circuit which gives and receives data to/from the HDD 14.

The graphics circuit 16 is a circuit which supplies an image signal to the display 2 to display an image thereon according to supplied data.

An interface 17 is a circuit which obtains the signal from the input unit 3.

An interface 18 is a circuit which gives and receives data to/from an external device not illustrated.

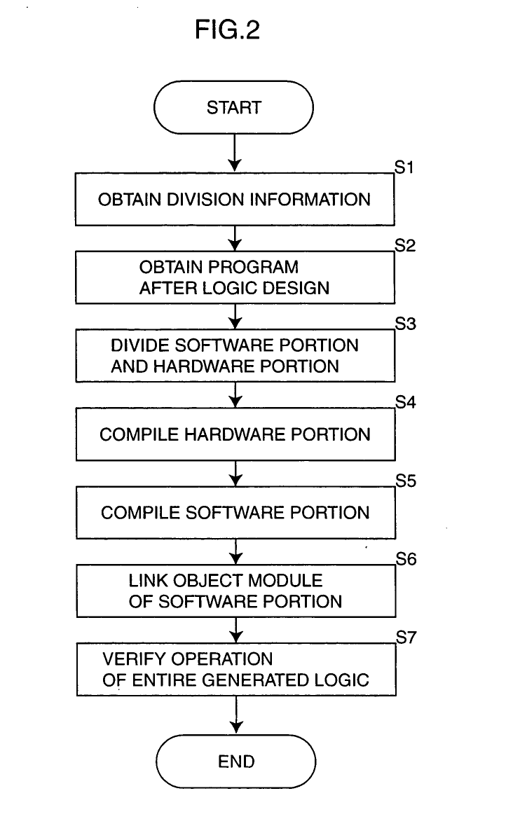

Next, operations of the computer 1 as this system development support device will be explained. FIG. 2 is a flowchart explaining operations of the system development support device shown in FIG. 1.

First, a program created in a single high-level language such as Programming Language C, in which a system is described, is prepared, for example, in the HDD 14 or the RAM 13 by a system developer.

Further, the division information which designates each portion of the program as either the hardware portion or the software portion is prepared, for example, in the HDD 14 or the RAM 13 by the system developer (step S1).

Incidentally, the division information includes information which, in each predetermined function block (a group composed of one or a plurality of routines to realize a predetermined function in the system), designates the function block to be realized as hardware or to be realized as software. When both of hardware and software are possible, this is designated or nothing is designated. Incidentally, this division information may be given as a parameter at the time of execution of the system development support program 21 without being stored in the HDD 14 or the like.

The CPU 11 then executes the division program 31 of the system development support program 21 in accordance with the manipulation of the system developer or automatically at the time of execution of the system development support program 21.

The CPU 11 reads the program in which the system is described in the single high-level language (hereinafter referred to as a target program) along the division program 31 (step S2), and referring to the division information, classifies each portion of the target program as either the hardware portion or the software portion (step S3).

On this occasion, for example, respective function blocks in the target program are classified as either the hardware portion or the software portion. When the target program is divided into respective function blocks, for example, a function block or the like realizing a function in which processing speed is demanded is allocated to the hardware portion.

For example, before creating the target program, that is, in a basic specification, the relation between each function to be realized and the name of its function block is determined, and the target program is created by describing a program regarding a function to be realized in its function block in a routine with the name of the function block; in the division information, for each function block, a pair of the name of the function block and information (hereinafter referred to as designation information) which designates the function block as either the hardware portion or the software portion is set. Thereby, in accordance with the division program 31, when detecting a routine with the same name as that of a function block set in the division information, the CPU 11 classifies the routine of the function block as either the hardware portion or the software portion based on the designation information on the name of the function block in the division information.

Incidentally, an example in which the target program is divided into each function block as a unit is shown above, but the target program may be divided into other units than function blocks, and also other methods may be adopted as a dividing method.

Following the division program 31, the CPU 11 stores a file of a program of the hardware portion (namely, one or a plurality of routines to be realized as hardware) and a file of a program of the software portion (namely, one or a plurality of routines to be realized as software) after the aforesaid division into the RAM 13 or into the HDD 14.

The CPU 11 then executes the compiler program 32. The CPU 11 compiles the high-level language program of the hardware portion into a program in a language corresponding to a circuit specification such as RTL according to the compiler program 32 (step S4). This program in a language corresponding to the circuit specification is temporarily stored in the RAM 13 or the HDD 14.

On the occasion of the compile of the hardware portion, hardware conditions such as the type of a used gate array, the upper limit of the number of gates, the sort of a process used in making an IC chip, the sort of a test circuit for IC chips which are mass-produced (The arrangement of pins of the IC chip is restricted depending on the sort of the test circuit.), and the like are referred to as compile conditions. The hardware conditions may be inputted by the system developer when the compiler program 32 is executed, or may be described in a file or the like in advance.

Moreover, on this occasion, constraints such as information on the relation of signal transfer between respective program portions may be described additionally in a file or the like as required. In this case, the CPU 11 generates a program of a circuit specification which satisfies the constraints such as the relation of signal transfer at a boundary between the hardware portion and the software portion in accordance with the compiler program 32.

Furthermore, the CPU 11 executes the compiler program 33. Along the compiler program 33, the CPU 11 compiles the high-level language program of the software portion into an object module (step S5).

On the occasion of this compile of the software portion, compile conditions such as the type of a CPU core being used, optimization option, and the like are referred to. The compile conditions may be inputted by the system developer when the compiler program 33 is executed, or may be described in a file or the like in advance.

On this occasion, constraints such as information on the relation of signal transfer between respective program portions may be described additionally in a file or the like as required. In this case, the CPU 11 generates the object module, for example, by appropriately amending the program of the software portion so that the constraints such as the relation of signal transfer at a boundary between the hardware portion and the software portion are satisfied.

Thereafter, the CPU 11 executes the linker program 34. In accordance with the linker program 34, the CPU 11 links the object module of the software portion of the target program with a module registered in the library not illustrated and other object modules to generate an execute form module (step S6).

In the above explanation, after the program of the hardware portion is compiled, the program of the software portion is compiled and linked, but it is suitable to compile the program of the hardware portion after the program of the software portion is compiled and linked. Moreover, the compile of the program of the hardware portion and the compile and linkage of the program of the software portion may be executed concurrently.

A logic of the entire system in which the hardware portion and the software portion mingle is thus generated. The circuit specification of the hardware portion is materialized for the verification of this logic. As an example of the materialization in this case, a simulator program to simulate a circuit based on the circuit specification of the hardware portion, a circuit produced by way of trial with a gate array capable of reconstructing the logic and the like, or the like is given. When the simulator program is used, the CPU 11 performs simulation of the circuit based on the circuit specification stored in the RAM 13 or the HDD 14 in accordance with the simulator program. When the trial circuit is used, the CPU 11 connects with the circuit via the interface 18.

The CPU 11 then executes the verification program 35. Along the verification program 35, the CPU 11 performs various inputs with respect to the logic of the entire system generated in a state in which the hardware portion and the software portion mingle, obtains logics in respective portions at that time, that is, signal behavior, outputs, results, and the like, decides whether the relation between the inputs and the behavior, outputs, results and the like satisfies the predetermined conditions or not, and verifies the logic of the entire system (step S7).

Incidentally, the CPU 11 may display the result of this verification on the display 2 or may print it by a printer not illustrated according to the verification program 35.

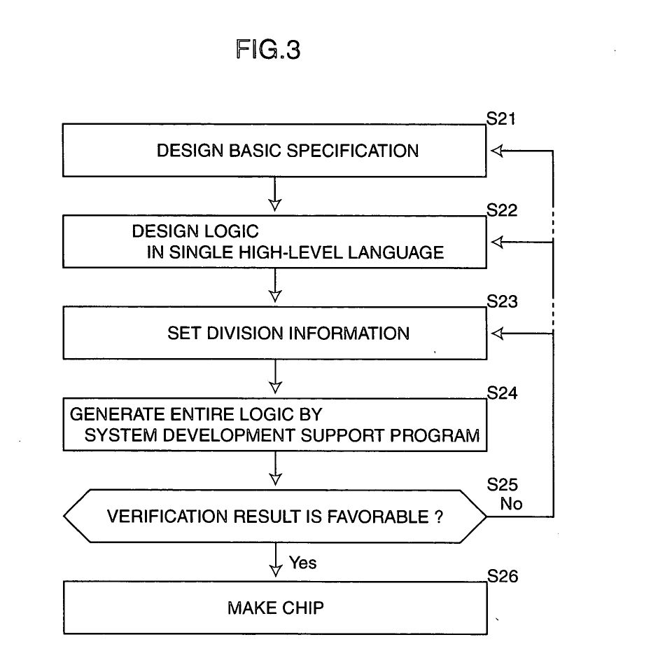

Next, the procedure to develop a system will be explained in case that the system development support device of the embodiment 1 is used. FIG. 3 is a flowchart explaining the procedure for developing the system when the system development support device of the embodiment 1 is used.

When system development is performed with the system development support device of the embodiment 1, as shown in FIG. 3, a basic specification is first designed by the system developer (step S21). In this basic specification, only specifications of various functions are determined. Namely, in this basic specification, the designation of a portion to be realized as hardware and a portion to be realized as software, the types of a CPU core and a gate array to be used, and the like are not determined in principle. However, as default, typical designation and types may be provisionally determined for these.

Subsequently, a logic specification is designed from the basic specification as a target program described in a single high-level language by the system developer (step S22).

Brand-new division information with respect to the target program is set through manual manipulation by the system developer or set automatically based on conditions of hardware of electronic equipment in which the system is incorporated (memory capacity, number of gates, and the like) and the like (step S23).

After that, when the system development support program 21 is executed, the computer 1 operates as described above, a logic of the entire system is generated, and a verification result of the logic is obtained (step S24).

Then, based on this verification result, the system developer decides whether the verification result is favorable or not (step S25). When the verification result is favorable, an IC chip which the designed system is materialized by is manufactured (step S26).

On the other hand, when the verification result is not favorable, the system developer changes the division information, changes the logic specification, or changes the basic specification depending on the situation. Processing is repeated in the same manner as described above until a favorable verification result is obtained.

As described above, according to the embodiment 1, following the system development support program 21, the computer 1 divides the target program, in which the logic specification of the system is described in the single high-level language, into the hardware portion and the software portion based on the division information, then converts the program of the hardware portion into the circuit specification and converts the program of the software portion into the execute form module. Consequently, the time required to complete the system in which the hardware portion and the software portion mingle can be shortened.

More specifically, since only the target program described in the single language and the division information need to be amended when the design is changed, cooperation between the hardware developer and the software developer becomes almost unnecessary, leading to improvement in development efficiency.

Moreover, it is possible to reduce involvement in the basic specification of an expert having advanced knowledge, and result in improvement in efficiency of practical use of developers.

Further, according to the embodiment 1, along the division program 31, the computer 1 determines in each function block of the target program whether the function block is a portion to be mounted as hardware or a portion to be mounted as software based on the division information, whereby the portion to be mounted as hardware and the portion to be mounted as software can be divided appropriately. Namely, by division into respective function blocks, for example, a group of routines for a function in which operation speed is demanded is collectively mounted as hardware, while a group of routines for a function which is suitable to be realized as software is collectively mounted as software.

Furthermore, according to the embodiment 1, along the verification program 35, the computer 1 verifies the circuit based on the circuit specification corresponding to the hardware portion, and the operation of the execute form module corresponding to the software portion. Therefore, the entire logic of the system generated from the target program in which the logic specification is described is verified collectively, and hence in addition to the verification of each operation of the hardware portion and the software portion, an operation based on the cooperation between both the portions can be verified.

Embodiment 2.

A system development support device according to the embodiment 2 of the present invention is realized by adding a division information generating program 36 which generates division information based on a specification of a system to the system development support program 21 of the system development support device according to the embodiment 1.

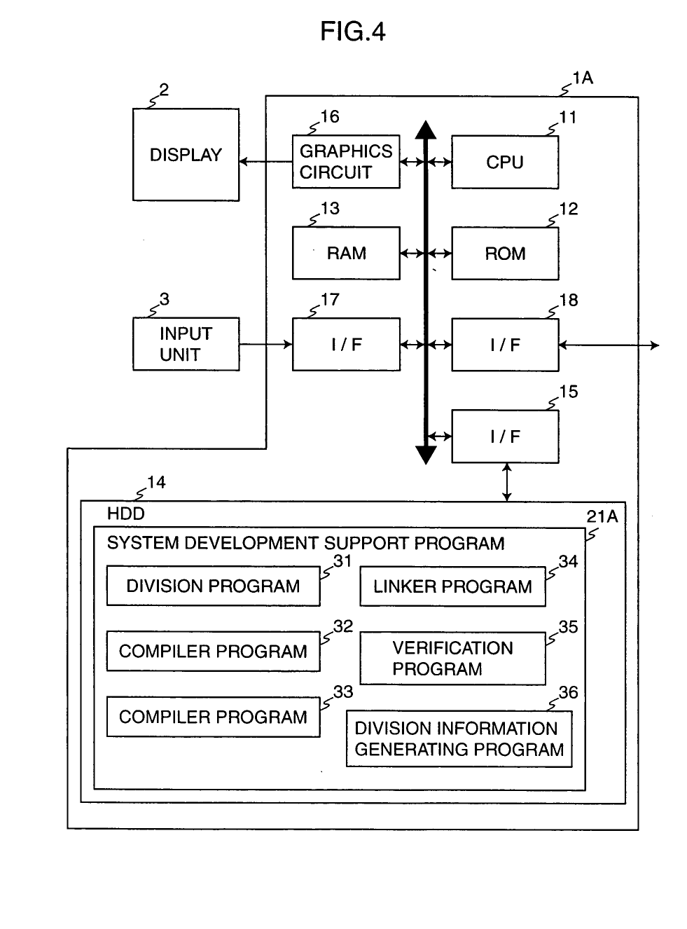

FIG. 4 is a block diagram showing the configuration of the system development support device according to the embodiment 2 of the present invention. In FIG. 4, a system development support program 21A is made by adding the division information generating program 36 which generates the division information based on the system specification to the system development support program 21 of the embodiment 1.

This division information generating program 36 is a program to allow a computer 1A to function as a division information generating means for generating the division information based on the system specification.

Incidentally, other components in FIG. 4 are the same as those in the embodiment 1, and hence the explanation thereof is omitted.

Next, operations of the aforesaid device will be explained.

The division information generating program 36 is executed by the CPU 11 when brand-new division information is generated or the division information is changed.

In this case, in accordance the division information generation program 36, the CPU 11 generates the division information based on the previously determined system specification.

For example, along the division information generating program 36, the CPU 11 generates the division information based on the system specification such as the chip size of an IC which realizes the system, the capacity of a memory (a ROM 113 or a flash ROM 115) in which an execute form module is stored in the system, the number of gates of a gate array 117 in which a circuit based on a circuit specification is executed in the system, and the like.

Alternatively, for example, in accordance with the division information generating program 36, the CPU 11 generates the division information based on at least one of the type of a CPU core used in the system, the function of a DSP used in the system, available hardware macros, and available software macros as well as the chip size, the capacity of the memory, and the number of the gates.

More specifically, a knowledge of the relation between the values of parameters (a chip size and the like) in the aforesaid system specification and a method of realizing a predetermined portion or a function block of a target program (hardware or software) is previously contained in the division information generating program 36, and the division information is generated, based on the knowledge, from the system specification.

Incidentally, other operations are the same as those in the embodiment 1, and hence the explanation thereof is omitted. Although the division information is automatically generated by adding the division information generating program 36 to the embodiment 1 in this embodiment 2, it is naturally possible to automatically generate the division information by adding the division information generating program 36 to other embodiments.

As described above, according to the embodiment 2, following the division information generating program 36, the computer 1A generates the division information based on the system specification. Accordingly, even if the system developer is not an expert, appropriate division information can be generated.

Further, according to the embodiment 2, along the division information generating program 36, the computer 1A generates the division information based on the capacity of the memory in which the execute form module is stored in the system and the number of the gates of the gate array in which the circuit based on the circuit specification is executed in the system, or based on at least one of the type of the CPU core used in the system, the function of the DSP used in the system, the available hardware macros, and the available software macros as well as the capacity of the memory and the number of the gates. Consequently, since the division information is generated based on these parameters in the system specification, more appropriate division information can be generated.

Embodiment 3.

A system development support device according to the embodiment 3 of the present invention is realized by adding an optimization program 51 which changes division information and so forth in accordance with a result of verification by the verification program 35 to optimize the verification result, to the system development support program 21 of the system development support device according to the embodiment 1.

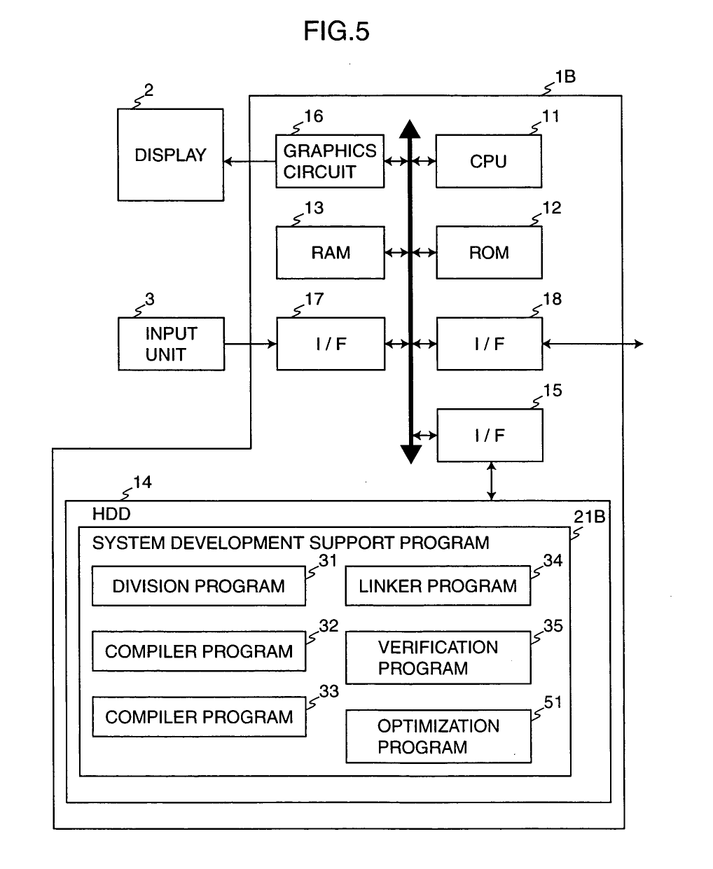

FIG. 5 is a block diagram showing the configuration of the system development support device according to the embodiment 3 of the present invention. In FIG. 5, a system development support program 21B is made by adding the optimization program 51 which changes the division information and so forth in accordance with the result of the verification by the verification program 35 to optimize the verification result, to the system development support program 21 of the embodiment 1.

Incidentally, this optimization program 51 is a program to allow a computer 1B to function as a division information changing means for changing the division information in accordance with the result of the verification by the verification program 35.

Moreover, the optimization program 51 is a program to allow the computer 1B to function as a division information changing means for changing the ratio of the hardware portion to the software portion in accordance with the result of the verification by the verification program 35.

Further, the optimization program 51 is a program to allow the computer 1B to function as a first condition changing means for changing a hardware condition of the system in accordance with the result of the verification by the verification program 35.

Furthermore, the optimization program 51 is a program to allow the computer 1B to function as a second condition changing means for changing a compile condition when the program of the software portion is converted into the execute form module by the compiler program 33 in accordance with the result of the verification by the verification program 35.

Moreover, the optimization program 51 is a program to allow the computer 1B to function as an optimization means for repeatedly executing the division program 31, the compiler program 32, the compiler program 33, the linker program 34, and the verification program 35 while changing at least one of the division information, hardware conditions on which the program of the hardware portion is converted into the circuit specification, and compile conditions on which the program of the software portion is converted into the execute form module until a predetermined verification result is obtained or only a predetermined number of repetitions.

Incidentally, other components in FIG. 5 are the same as those in the embodiment 1, and therefore the explanation thereof is omitted.

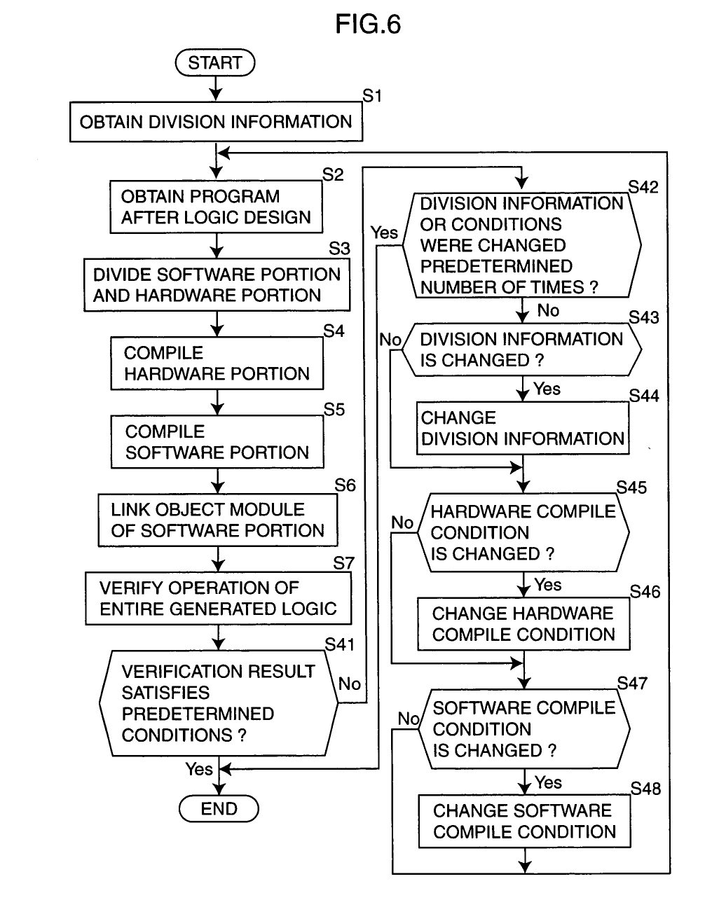

Next, operations of the aforesaid device will be explained. FIG. 6 is a flowchart explaining operations of the system development support device shown in FIG. 5.

This system development support device generates a logic of the entire system and verifies the logic in accordance with the system development support program 21B, in the same manner as in the embodiment 1 (steps S1 to S7).

Then, the CPU 11 executes the optimization program 51.

Following the optimization program 51, the CPU 11 first decides whether a verification result satisfies predetermined conditions or not (step S41).

On this occasion, for example, whether or not a delay time of each of various signals is more than a predetermined value, whether or not a verification result of the operation of a function is the desired one, and the like are decided.

When deciding that the verification result satisfies the predetermined conditions, the CPU 11 ends designing of the circuit specification of the system in accordance with the optimization program 51.

Meanwhile, when deciding that the verification result does not satisfy the predetermined conditions, the CPU 11 decides whether the division information, hardware compile conditions, software compile conditions, and the like are changed the predetermined number of times, in accordance with the optimization program 51 (step S42).

On this occasion, also when deciding that the division information, the hardware compile conditions, the software compile conditions, and the like are changed the predetermined number of times, according to the optimization program 51, the CPU 11 ends the automatic designing of the circuit specification of the system.

Meanwhile, when deciding that the division information, the hardware compile conditions, the software compile conditions, and the like are not changed the predetermined number of times, the CPU 11 changes at least one of the division information, the hardware compile conditions, the software compile conditions according to the optimization program 51 (steps S43 to S48).

First, along the optimization program 51, the CPU 11 decides whether or not to change the division information based on the verification result (step S43), and changes the division information as necessary (step S44).

For example, when the system is in poor operation due to low processing speed of some routine or some function block of the software portion as the result of the verification, the routine or the block function is changed into the hardware portion if there are gates to spare in the gate array. Meanwhile, when there are no gates to spare in the gate array in the above case, out of routines or function blocks of the hardware portion, any one changeable into the software portion is changed into the software portion, and the routine or the function block of the software portion, which causes the poor operation, is changed into the hardware portion. Incidentally, the number of remaining gates of the gate array can be obtained if the number of gates corresponding to the hardware portion after compile is subtracted from the number of mountable gates.

When the number of gates corresponding to the hardware portion after compile exceeds the number of mountable gates, for example, any of routines or function blocks of the hardware portion is changed into the software portion. On this occasion, the selection of a routine or a function block to be changed into the software portion may be performed by the system developer, or may be automatically performed along the optimization program 51 according to the number of gates corresponding to the routine or the function block or the like.

As stated above, in this case, following the optimization program 51, the CPU 11 changes the ratio of the hardware portion to the software portion according to the verification result.

Thereafter, following the optimization program 51, the CPU 11 decides whether or not to change a compile condition of the hardware portion, that is, a hardware condition based on the verification result (step S45), and changes the compile condition of the hardware portion as required (step S46).

For example, when poor operation occurs to the software portion because the input/output timing of signals from the hardware portion to the software portion is not correct, the input/output timing of signals from the hardware portion to the software portion is changed by delaying the signals.

Along the optimization program 51, the CPU 11 then decides whether or not to change a compile condition of the software portion based on the verification result (step S47), and changes the compile condition of the software portion as required (step S48).

For example, the type of a CPU core used in the system is changed according to the verification result. When operations of the majority of routines or function blocks in the software portion are slow, the CPU core is changed to one having high processing speed. In this case, the types and performance of mountable CPU cores are previously enumerated. A CPU core is selected out of them suitably in accordance with the optimization program 51.

For example, an optimization option at the time of compile is changed according to the verification result. There are an option for size, an option for speed and the like in the optimization option.

As described above, at least one of the division information, the hardware conditions and the software compile conditions is changed.

Incidentally, which one of the division information, the hardware conditions, and the software compile conditions is changed may be determined according to the number of repetitions or the like. More specifically, it is suitable to change only the hardware conditions and the software compile conditions in the predetermined number of times first and thereafter change only the division information.

After at least one of the division information, the hardware conditions and the software compile conditions is thus changed, division processing is performed again for the program in which the logic specification is described, and the divided hardware portion and software portion are processed respectively to generate the logic of the entire system.

This processing is performed repeatedly until it is decided in step S41 that the verification result satisfies the predetermined conditions or until it is decided in step S42 that the number of times of this repetitive processing reaches the predetermined number of times.

Next, the procedure to develop the system will be explained in case that the system development support device of the embodiment 3 is used will be explained. The procedure for developing the system with the system development support device of the embodiment 3 is similar to that in the embodiment 1 (FIG. 3). In the embodiment 3, however, the frequency of setting/change of the division information by the system developer is reduced by performing the optimization processing.

Further, for example, it is suitable to make changes in the division information, the compile conditions and so forth by manual work by the system developer the predetermined number of times first, and thereafter automatically by the optimization program 51 such as described above.

Furthermore, it is suitable to make changes in the division information, the compile conditions and so forth by manual work by the system developer until the number of errors in the verification result reduces to a predetermined number or less, and thereafter automatically by the optimization program 51 such as described above.

Thus, the system can be developed efficiently.

As stated above, according to the embodiment 3, following the optimization program 51, the computer 1B repeats the generation of the entire logic of the system based on the target program while changing at least one of the division information, the hardware conditions and the software compile conditions until the predetermined verification result is obtained or only the predetermined number of repetitions in accordance with the result of the verification by the verification program 35. Consequently, the frequency of setting/change of the division information by the system developer is reduced, whereby especially the working volume of a rare expert can be reduced and the time required for the development of the system can be further shortened.

Moreover, according to the embodiment 3, along the optimization program 51, the computer 1B changes the division information in accordance with the result of the verification by the verification program 35. Hence, the frequency of setting/change of the division information by the system developer is reduced, whereby especially the working volume of the rare expert can be reduced and the time required for the development of the system can be further shortened.

Further, according to the embodiment 3, following the optimization program 51, the computer 1B changes the ratio of the hardware portion to the software portion in accordance with the result of the verification by the verification program 35. Thereby, without particularly changing hardware conditions (the capacity of the memory, the number of gates, and the like) of the system, a circuit which meets the hardware conditions is designed.

Furthermore, according to the embodiment 3, following the optimization program 51, the computer 1B changes the hardware condition, which are referred to when the hardware portion is compiled, in accordance with the result of the verification by the verification program 35. Therefore, the frequency of change of the hardware conditions by the system developer is reduced, whereby especially the working volume of the rare expert can be reduced and the time required for the development of the system can be further shortened.

On this occasion, the computer 1B changes, for example, the input/output timing of signals between the hardware portion and the software portion in accordance with the verification result. Hence, poor operation due to transmission of signals between the hardware portion and the software portion can be avoided.

In addition, according to the embodiment 3, along the optimization program 51, the computer 1B changes the compile condition on which the program of the software portion is converted into the execute form module in accordance with the result of the verification by the verification program 35. Consequently, the frequency of change of the software compile conditions by the system developer is reduced, whereby especially the working volume of the rare expert can be reduced and the time required for the development of the system can be further shortened.

On this occasion, the computer 1B changes the type of the CPU core used in the system in accordance with the verification result. Thereby, the operating speed of the entire software portion can be regulated.

Incidentally, in the aforesaid embodiments 1 to 3, the division information is supplied to the division program 31 without being described specifically in the target program, but it is also suitable that the division information is described explicitly in the target program and the division program 31 performs division processing based on this division information.

It is naturally possible to use language such as C++ derived from Programming Language C or programming language totally different from Programming Language C as the high-level language instead of Programming Language C.

Moreover, in the aforesaid embodiments 1 to 3, the case where the developed system is mounted as an IC chip is stated as an example, but the present invention also can be applied to designing of a system to be mounted as a circuit board including an IC chip.

### INDUSTRIAL AVAILABILITY

According to the present invention, a system development support device, a system development support method, and a computer readable record medium being capable of shortening the time required to complete a system in which a hardware portion and a software portion mingle can be obtained.

1. A system development support device, comprising:
a division means for dividing a program, in which a logic specification of a system is described in a single high-level language, into a hardware portion and a software portion based on division information which designates each portion of the program as either the hardware portion or the software portion;
a storage means for storing a program of the hardware portion and a program of the software portion which are divided by said division means;
a first conversion means for converting the program of the hardware portion stored in said storage means into a circuit specification; and
a second conversion means for converting the program of the software portion stored in said storage means into an execute form module.

2. A system development support device, comprising:
a division means for dividing a program, in which a logic specification of a system is described in a single high-level language, into a hardware portion and a software portion based on division information which designates each portion of the program as either the hardware portion or the software portion;
a storage means for storing a program of the hardware portion and a program of the software portion which are divided by said division means;
a first conversion means for converting the program of the hardware portion stored in said storage means into a circuit specification; and
a second conversion means for converting the program of the software portion stored in said storage means into an execute form module,
said division means determining, in each function block of the program described in the single high-level language, whether the function block is a portion to be mounted as hardware or a portion to be mounted as software based on the division information.

3. The system development support device according to claim 1, further comprising:
a division information generating means for generating the division information based on a specification of the system.

4. The system development support device according to claim 1, further comprising:
a division information generating means for generating the division information based on capacity of a memory in which the execute form module is stored in the system and number of gates of a gate array in which a circuit based on the circuit specification is performed in the system or based on at least one of a type of a CPU core used in the system, a function of a DSP used in the system, available hardware macros, and available software macros as well as the capacity of the memory and the number of the gates.

5. The system development support device according to claim 1, further comprising:
a verification means for verifying a circuit based on the circuit specification resulting from the conversion by said first conversion means and an operation of the execute form module resulting from the conversion by said second conversion means.

6. The system development support device according to claim 5, further comprising:
a division information changing means for changing the division information in accordance with a result of verification by said verification means.

7. The system development support device according to claim 5, further comprising:
a division information changing means for changing a ratio of the hardware portion to the software portion in accordance with a result of verification by said verification means.

8. The system development support device according to claim 5, further comprising:
a first condition changing means for changing a hardware condition which said first conversion means refers to when converting the hardware portion into the circuit specification in accordance with a result of verification by said verification means.

9. The system development support device according to claim 5, further comprising:
a first condition changing means for changing a hardware condition which said first conversion means refers to when converting the hardware portion into the circuit specification in accordance with a result of verification by said verification means,
said first condition changing means changing input/output timing of signals between the hardware portion and the software portion in accordance with the result of the verification by said verification means.

10. The system development support device according to claim 5, further comprising:
a second condition changing means for changing a compile condition on which said second conversion means converts the program of the software portion into the execute form module in accordance with a result of verification by said verification means.

11. The system development support device according to claim 5, further comprising:
a second condition changing means for changing a compile condition when said second conversion means converts the program of the software portion into the execute form module in accordance with a result of verification by said verification means,
said second condition changing means changing a type of a CPU core used in the system in accordance with the result of the verification by said verification means.

12. The system development support device according to claim 5, further comprising:
an optimization means for repeatedly operating said division means, said first conversion means, said second conversion means and said verification means while changing at least one of the division information, hardware conditions on which said first conversion means converts the program of the hardware portion into the circuit specification, compile conditions on which said second conversion means converts the program of the software portion into the execute form module, until a predetermined verification result is obtained or only a predetermined number of repetitions.

13. A system development support method, comprising the steps of
dividing a program, in which a logic specification of a system is described in a single high-level language, into a hardware portion and a software portion based on division information which designates each portion of the program as either the hardware portion or the software portion;
converting a program of the hardware portion into a circuit specification; and
converting a program of the software portion into an execute form module.

14. A computer readable record medium on which recorded is a system development support program to allow a computer to function as:
a division means for dividing a program, in which a logic specification of a system is described in a single high-level language, into a hardware portion and a software portion based on division information which designates each portion of the program as either the hardware portion or the software portion and storing a program of the hardware portion and a program of the software portion in a storage means;
a first conversion means for converting the program of the hardware portion stored in the storage means into a circuit specification; and
a second conversion means for converting the program of the software portion stored in the storage means into an execute form module.

15. A computer readable record medium,
wherein a division program to allow a computer to function as a division means for dividing a program, in which a logic specification of a system is described in a single high-level language, into a hardware portion and a software portion based on division information which designates each portion of the program as either the hardware portion or the software portion and storing a program of the hardware portion and a program of the software portion in a storage means is recorded.
